(19) United States
(12) Patent Application Publication
(10) Pub. No.: US 2021/0268871 A1
(43) Pub. Date: Sep. 2, 2021

(54) CONTROL SYSTEM FOR HYDRONIC HEATER AND METHOD OF OPERATING SAME

(71) Applicant: International Thermal Investments Ltd., Richmond (CA)

(72) Inventors: Nader Kiarostami, Richmond (CA); Farzin Akhoundsadegh, Richmond (CA)

(21) Appl. No.: 16/805,752

(22) Filed: Feb. 29, 2020

(51) Int. Cl. B60H 1/22; B60H 1/00

(52) U.S. Cl. CPC B60H 1/2206; B60H 1/00364; B60H 1/2209; B60N 3/18; B60H 2001/2278; B60H 2001/2284; B60H 1/00885

(57) ABSTRACT

A control system for a burner assembly used in vehicles and boats particularly for a coolant storage type heater and a method of operating the control system. Resistors for producing a resistance change as a function of temperature are utilised to send temperature signals to the control system from both the coolant and the potable water by being in contact with coolant and potable water throughout burner operation. The use of the thermistor signals together with the signals from aquastats allows flexible heater operation and may be dependent upon the user where commands can be entered in a touch screen connected to the control board of the control system.

### INTRODUCTION

This invention relates to an improved heater and, more particularly, to an improved diesel powered hydronic heater with a control system and to a method of operating such a heater and its associated control system.

### BACKGROUND OF THE INVENTION

Hydronic heating systems are used in a variety of applications from heating homes to pervasive use in trucks, buses, recreational vehicles and boats, usually being in the high end market motorhomes and boats. Less expensive motorhomes and boats may use a hot air heating system where cooler air enters a heater typically using a hot coil. The cooler air is then heated by the coil and blown by a fan into the living quarters. A separate hot water heating system is typically also used in the less expensive market where a tank of potable water is heated by an immersion coil, an immersion electric element or a heating coil surrounding the water tank by a hot coolant which leaves the heater and travels to the coil, for example. When user demand for hot water is initiated by turning on a faucet, the heated hot water will leave the tank and travel under the influence of a pump to the open faucet. Cooler water is maintained in a standard and separate tank and a mixing valve is typically provided to allow the water leaving from the faucet to be at a predetermined temperature.

Hydronic heating systems in the higher end motorhome market combine the separate coolant tank into the heater and therefor eliminate the need for a separately located water heater by integrating a heat exchanger to draw heat from the hot coolant tank. Although there are exceptions, there is a usually a holding tank storing potable cooler water associated with a diesel burner. The coolant associated with the burner is heated. By the use of heat exchange, the heated coolant transfers heat to the cooler potable water. This provides heated potable water to the faucets of the motorhome or boat or other living quarters. The heated coolant is also circulated directly from the coolant tank to radiators and/or fans located in the living quarters and other areas of the motorhome where heat is desired.

A problem with many hydronic heating systems is that the tank of coolant needs to be maintained at a temperature which will provide the necessary heat to the potable water through heat transfer to enable a comfortable water temperature for many different purposes. The factors in play in designing such a system include the size of the tank, the quantity of coolant present, the heat quantity that can be applied to the coolant, the time of heat application and its duration and the distance of the faucets from the point at which heat transfer takes place.

Heretofore, the temperature of the coolant and/or the heated potable water tank has been measured by an aquastat. Aquastats measure the surface temperatures of the tank and not the coolant itself which causes inaccuracies in measuring coolant and water temperatures. They sense a high temperature and a low temperature of the coolant tank in a predetermined range. Typically, when the high limit is sensed, any heat applied to the coolant and/or potable water will be terminated because no additional heat is required. When a low limit is sensed, heat will be applied to the coolant, typically by the burner furnace powered by diesel fuel.

Two disadvantages with aquastats is that they are not precise acting devices and they are not particularly fast acting devices. The accuracy over which they perform their sensing operation is variable and there is an inherent minimum range between the opening and closing points. This minimum range cannot be reduced due to the mechanical nature of the aquastat. Of course, with greater manufacturing attention, precision can be improved. But there is still a minimum range of temperatures about which they may act and they are slow to act. A differential or “diff” control may provide a narrower sensing range but this increases the expense of the aquastat and the range is still limited. Aquastat use is inherently disadvantageous for precise control applications.

A thermistor is a type of resistor whose resistance varies with the temperature sensed. They are accurate. There are two types. A NTC type thermistor has resistance that decreases while the temperature rises. A PTC thermistor has resistance that increases as the temperature rises. They can achieve precision accuracies over a wide range of temperatures. Thermistors can also be immersed in the potable water or coolant using an appropriate probe housing so that any temperature reading obtained can be almost instantaneous and far more accurate than sensing the temperature of the surface of the tank outside the tank casing in which the coolant or water is held. By the use of an appropriate control system, changes in the operation of the burner and its associated components can likewise be instructed quickly and safely. This also increases operating efficiency.

### SUMMARY OF THE INVENTION

According to a first aspect of the invention, there is provided a hydronic heating system comprising a source of potable water, a coolant reservoir to hold coolant, a heat exchanger to exchange heat between said coolant and said potable water, a thermistor to sense the temperature of coolant in said coolant reservoir and to send a signal corresponding to said temperature sensed to said control system, a burner assembly controlled by said control system to apply heat to said coolant, said control system initiating or terminating combustion within said burner assembly thereby to regulate the heat applied to said coolant in said coolant reservoir.

According to a further aspect of the invention, there is provided a temperature sensing system comprising a coolant tank, a coolant line extending from said coolant tank to a heat exchanger and an temperature sensing resistive device mounted on said heat exchanger.

According to yet a further aspect of the invention, there is provided a method of controlling a hydronic heating system comprising heating a source of coolant by a burner, passing coolant from a source of said coolant through a heat exchanger under the direction of a control system, measuring the temperature of said coolant by a thermistor being a resistor producing an electrical signal responsive to changes of resistance by the change of temperature in said coolant, processing said electrical signal in said control system and producing an output signal from said control system to said burner to commence, continue or terminate said heating of said coolant.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic flow diagram of a diesel powered hydronic heating system in a dual loop heating configuration including a flow switch in the cold water line;

FIG. 2 is a diagrammatic isometric and partially exploded view of the hydronic heater shown in FIG. 1 with the outer case removed for illustrative purposes and particularly illustrating the placement of the flow switch in the potable water line and further illustrating the aquastat bank previously used for heater operation;

FIG. 3 is a diagrammatic isometric and partially exploded view of the hydronic heater of FIG. 2 but also illustrating the outer case;

FIG. 4 is a diagrammatic isometric and partially exploded view of the coolant tank, burner box and burner assembly and particularly illustrating the coolant tank and potable water thermistors in a heater with a dual loop configuration and the control system according to the invention;

FIG. 5 is a diagrammatic isometric view of the heater of FIG. 4 but not illustrating the burner box and burner in order to show the position of the electric elements within the coolant tank for electric AC heating operation and illustrating the thermistor positions and the flow switch orientation on a heater utilising the control system and touch screen according to the invention;

FIGS. 6A and 6B are diagrammatic top and isometric views of the potable water connections from and to the heat exchanger particularly illustrating the flow switch and an aquastat which is connected to the face of the heat exchanger;

FIG. 7 is a diagrammatic schematic of the touch screen used with the heater of FIGS. 4 and 5;

FIGS. 8A-8D are diagrammatic schematics of the control board used with the heater of FIGS. 4 and 5;

FIG. 9 is a diagrammatic flow chart of the logic diagram associated with the control system incorporating the thermistors used in the heater illustrated in the FIGS. 4 and 5 embodiment; and

FIGS. 10A-10L illustrate the various conditions of the touch screen which allow a user to interface with the control system and the heater.

### DESCRIPTION OF SPECIFIC EMBODIMENT

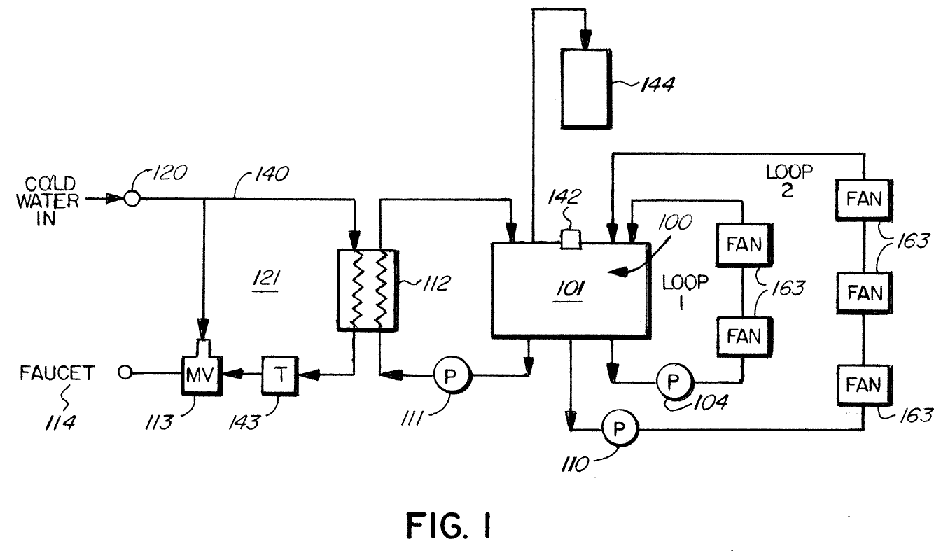

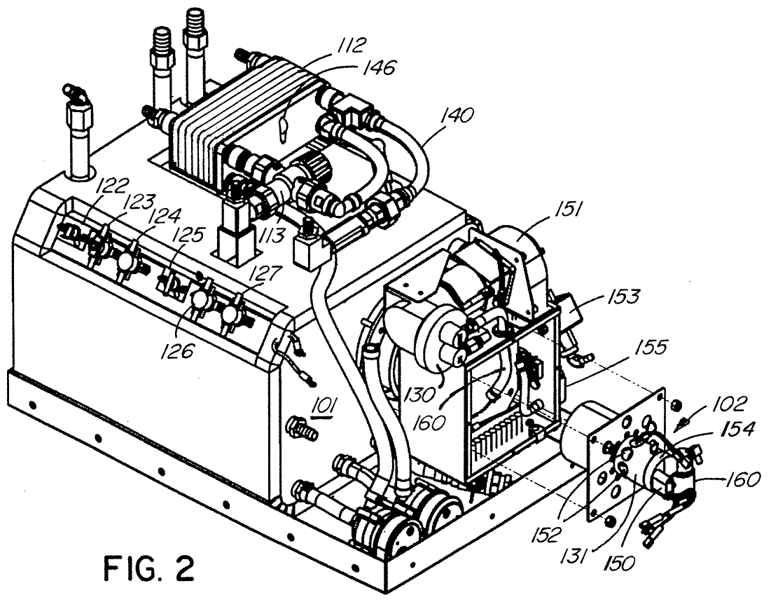

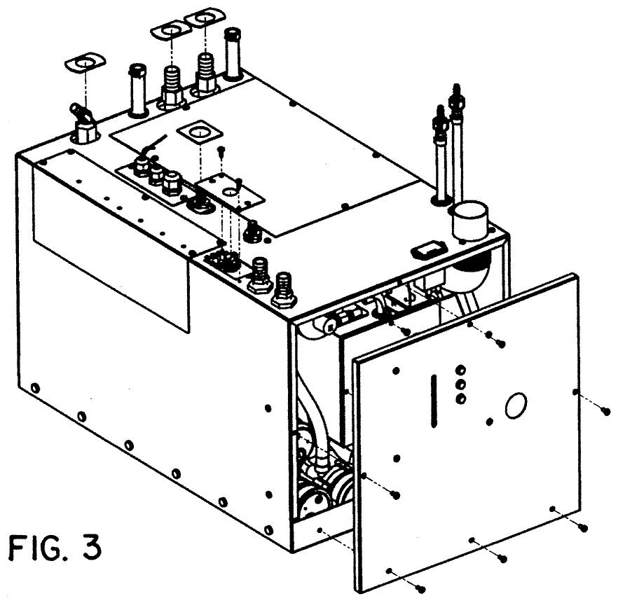

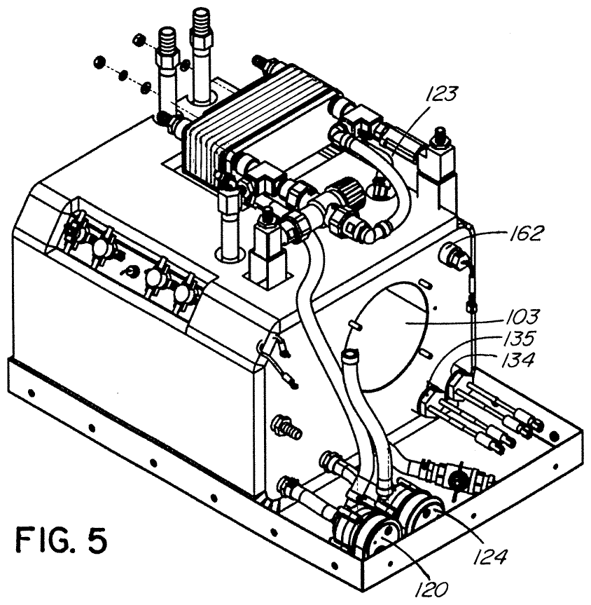

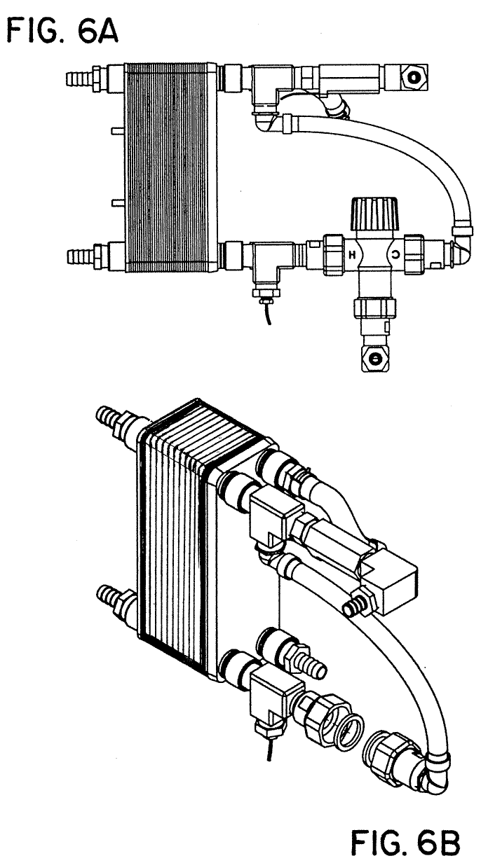

Referring now to the drawings, a dual loop hydronic heater according to the invention is generally illustrated at 100 in FIG. 1. While such a hydronic heater may be powered by electricity, liquid fuel other than diesel fuel or by gas or propane, the heater 100 of FIG. 1 is a diesel powered heater. The diesel powered heater 100 is known as an OASIS CHINOOK (Trademark) dual loop heater manufactured by International Thermal Research Ltd. of Richmond, BC, Canada. The heater 100 includes a coolant tank 101 (best illustrated in FIG. 2) made of stainless steel and configured in a generally rectilinear configuration. It includes a burner assembly generally illustrated at 102 and a burner chamber generally illustrated at 103 (FIG. 5) within which the burner assembly 102 and other components of the heater 100 are inserted.

Three circulation pumps 104, 110, 111 (FIG. 1) are provided for the two loop configuration illustrated. Pump 104 provides the necessary pressure to circulate coolant through LOOP 1, pump 110 circulates coolant through LOOP 2 and pump 111 circulates coolant through the heat exchanger 112. It will be appreciated that two loops are used for two different living areas of the boat or vehicle. The number of loops could be increased for larger boats or vehicles or a single loop could suffice for smaller boats or vehicles.

An RV or boat will have a source of potable water for washing, bathing, cooking and the like typically in an on board tank (not illustrated). A shore connection may also be used where available to allow hook up to a city water supply bypassing the water storage tank and providing pressure directly to the potable water system. A pump (not illustrated) external to the on board tank will be used to draw water from the potable water within the tank and provide pressure to the potable water system. In either case, cold water will be delivered from the source of water under pressure and proceed to the heater exchanger 112 as is illustrated in FIG. 1. The cold water passes through the heat exchanger 112 where it is heated by the coolant coming from the coolant tank 101 (FIGS. 1 and 2). A mixing valve 113 allows adjustment of the temperature of the potable water leaving the faucet 114 (FIG. 1) as is known.

A flow switch 120 (FIGS. 1 and 2) is provided in the potable water circuit 121 to detect the flow of potable water in the potable water circuit. A series of six (6) aquastats 122, 123 124, 125, 126, 127 (FIG. 2) are provided to measure the temperature of the coolant. Aquastat 122 is a heat available aquastat which measures the temperature of tank coolant and provides information on how much heat is available in the coolant tank 101. Aquastat 123 is a safety aquastat used to monitor the temperature of the tank coolant and to shut down the system if the temperature of the coolant is excessive. Aquastat 123 is conveniently set for closing at 205 deg.F. Aquastat 124 is a high limit aquastat used to terminate the operation of the burner 102 when the high limit temperature of the coolant has been reached and has an open condition convenient set for 190 deg.F. High limit and safety aquastats 124, 123 interface with the upper portion of the coolant tank 101 where the temperature of the coolant is the highest. The two aquastats 123, 124 are wired in series with the ground wire of compressor 130. In the event either of the aquastats 123, 124 sense a temperature exceeding their desired open positions, the contacts within the aquastats 123, 124 will open which will terminate power to the compressor 130. This will terminate fuel delivery to the nozzle holder 131 and its associated nozzle and therefore extinguish any flame in the burner chamber 103 (FIG. 5). Heat available aquastat 122 will close at approximately 125 deg.F. thereby to indicate to the zone board that the coolant is at at least that temperature and that heat is available in the coolant. If there then is a call for space heating, potable hot water or vehicle engine preheat (not illustrated), operation of the appropriate ones of the coolant pumps 104, 110, 111 will be initiated. Cycling aquastat 125 monitors the low temperature of the coolant and initiates operation of the burner assembly 102 to heat the coolant. It further terminates the burner operation when the maximum operating temperature is reached. Aquastats 126, 127 are the AC high limit aquastats used when the system is running off AC shore power and are associated with the electric elements 134, 135 (FIG. 5). Aquastats 126, 127 will open at 190 deg.F. and terminate operation of the electric elements 134, 135 if the cycling aquastat 125 fails to terminate operation of the electric elements 134, 135.

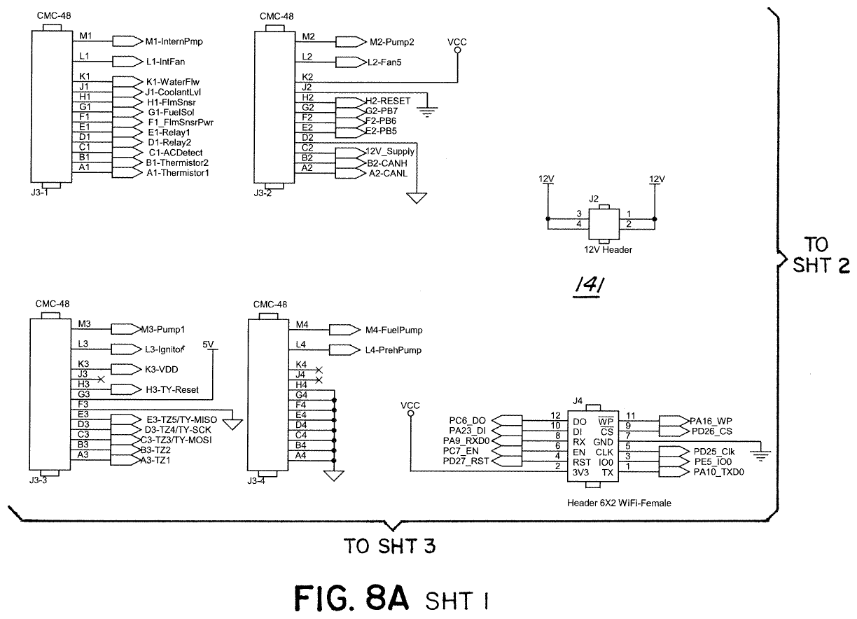

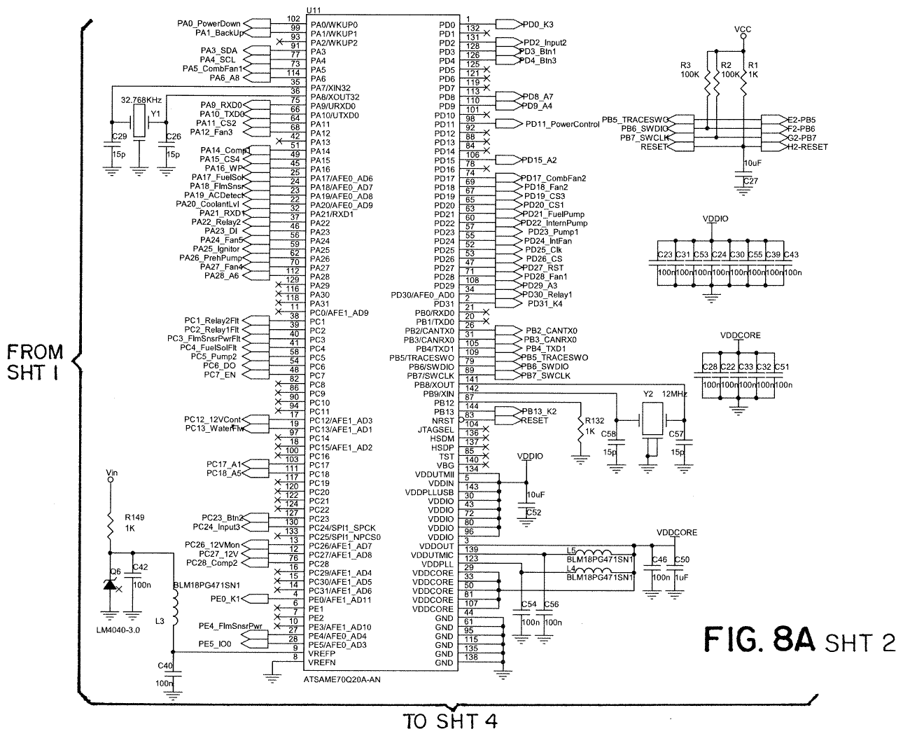

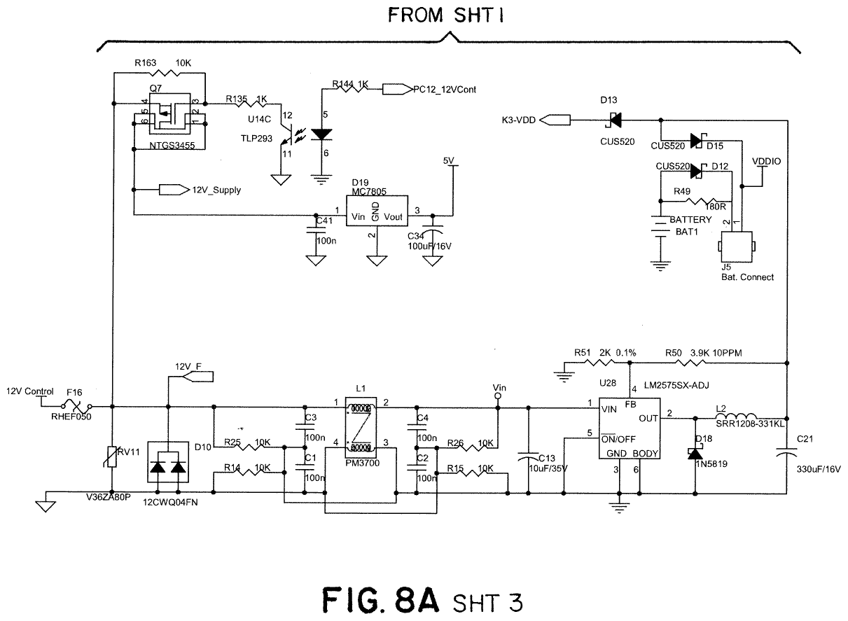

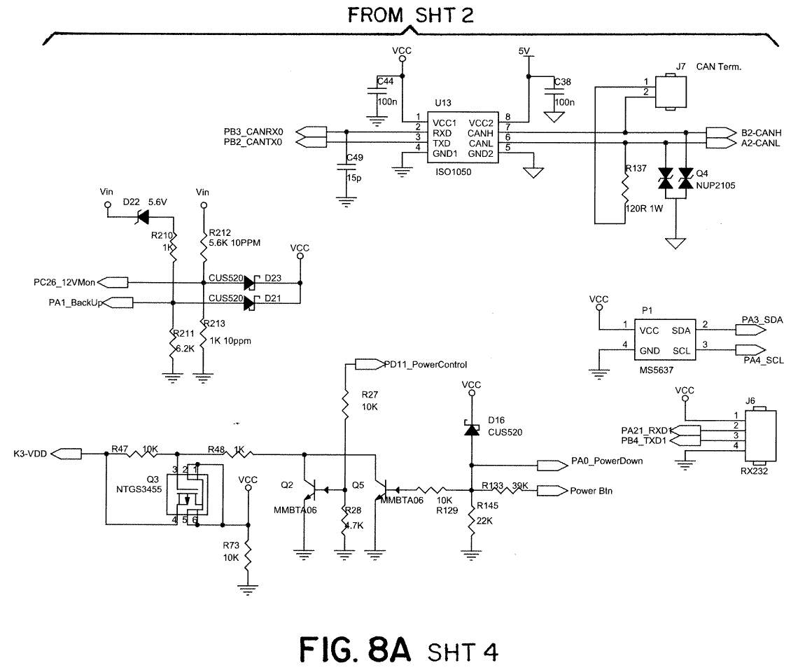

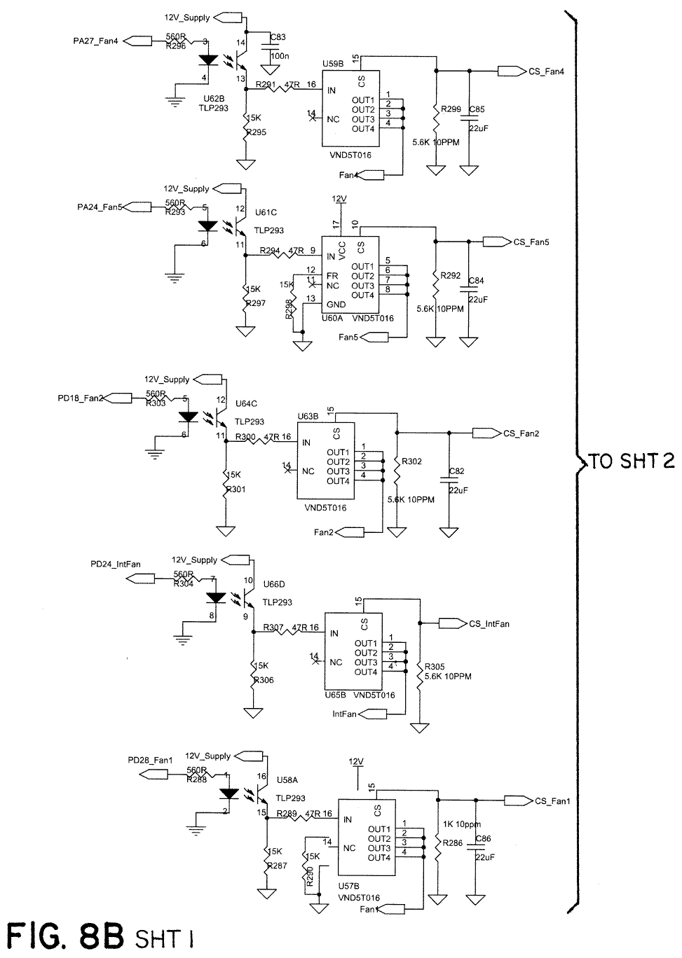

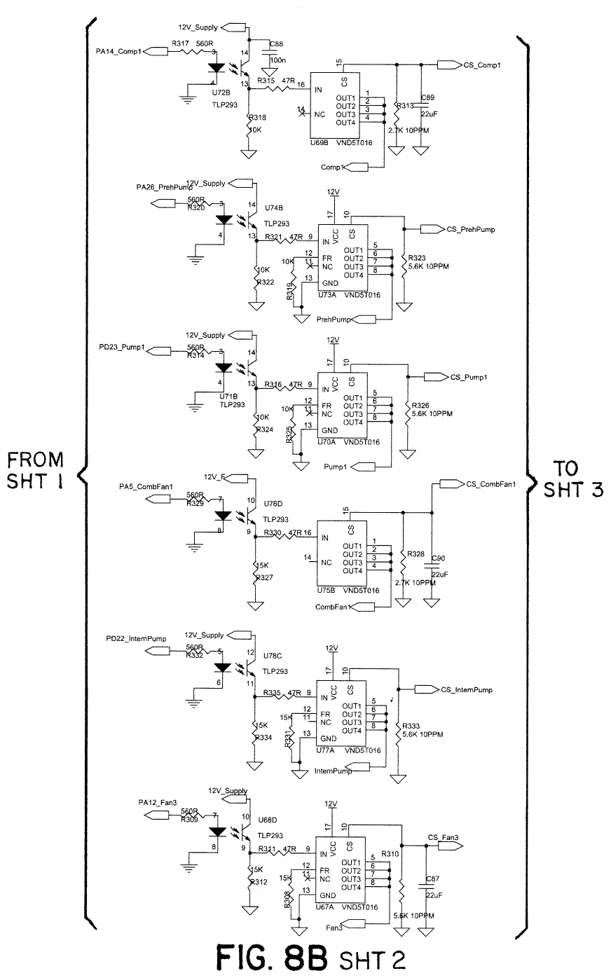

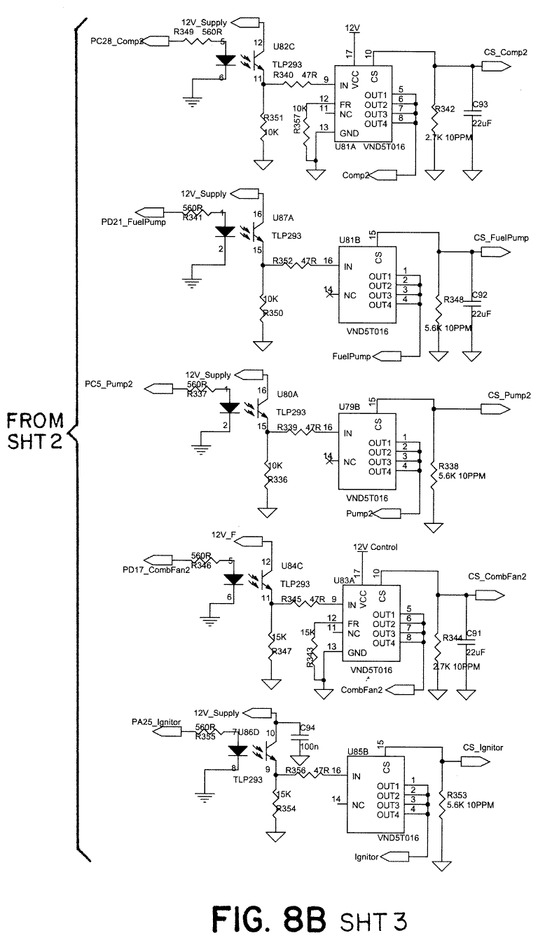

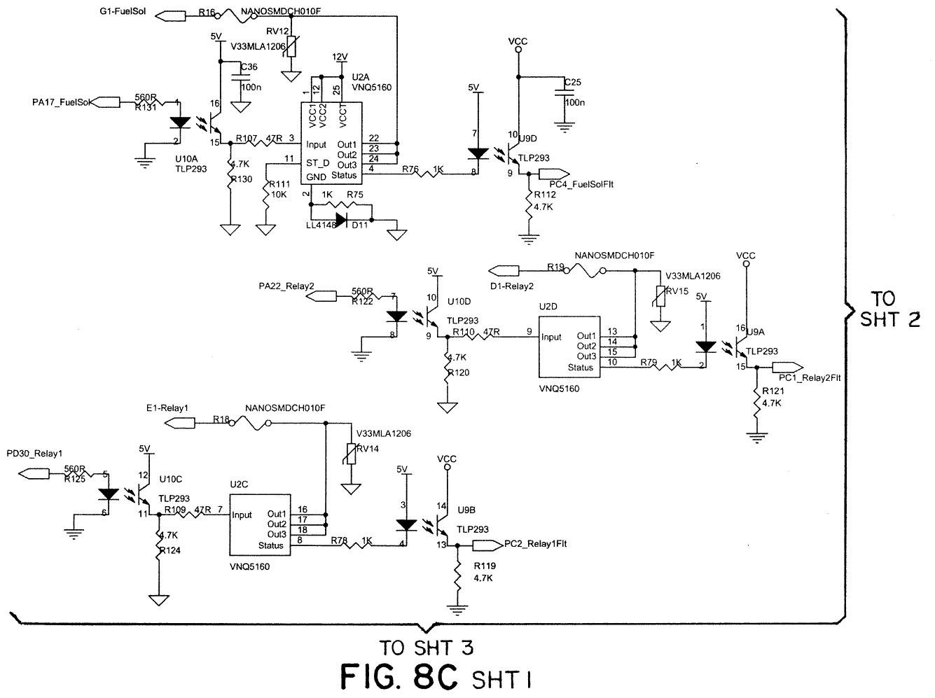

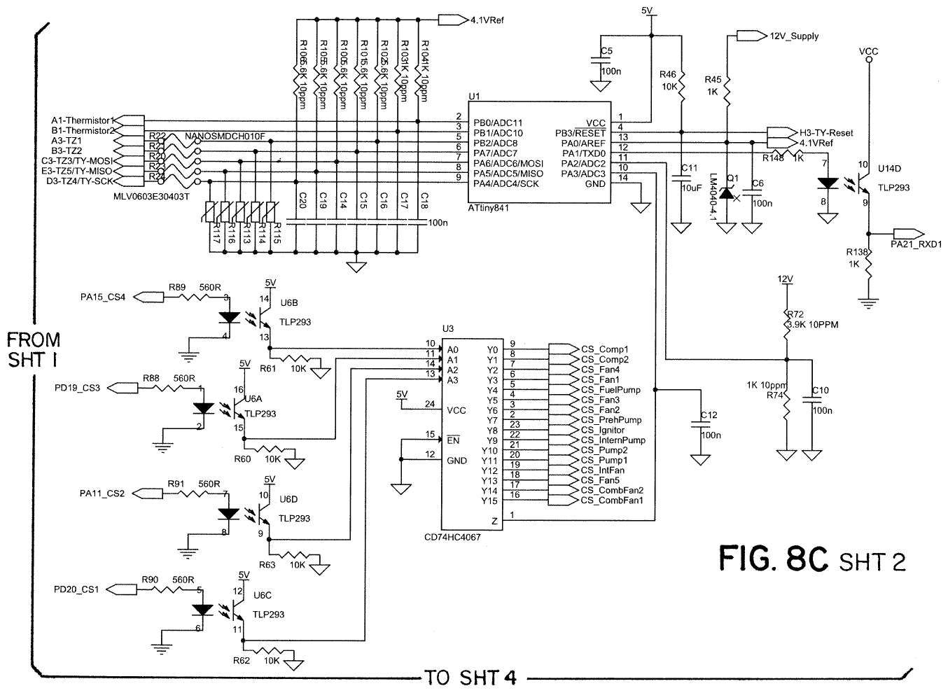

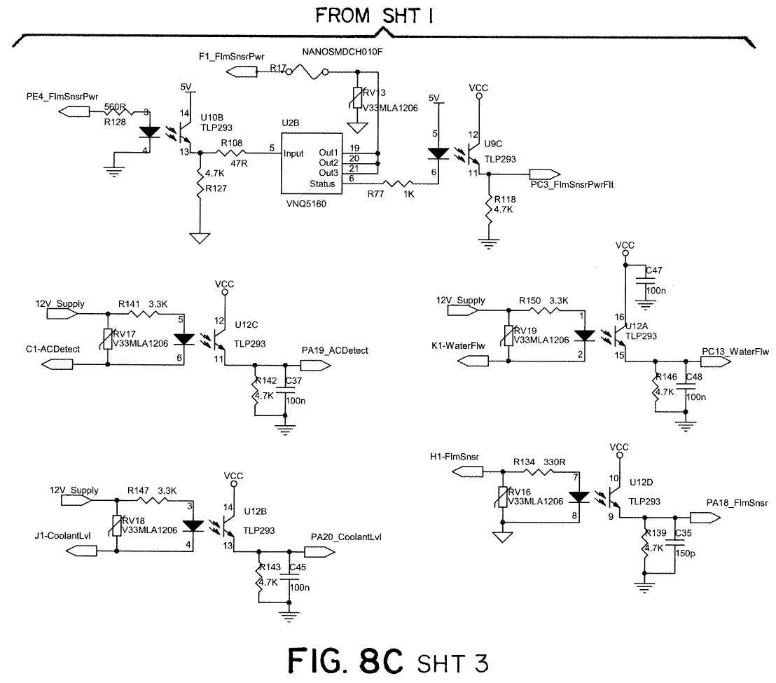

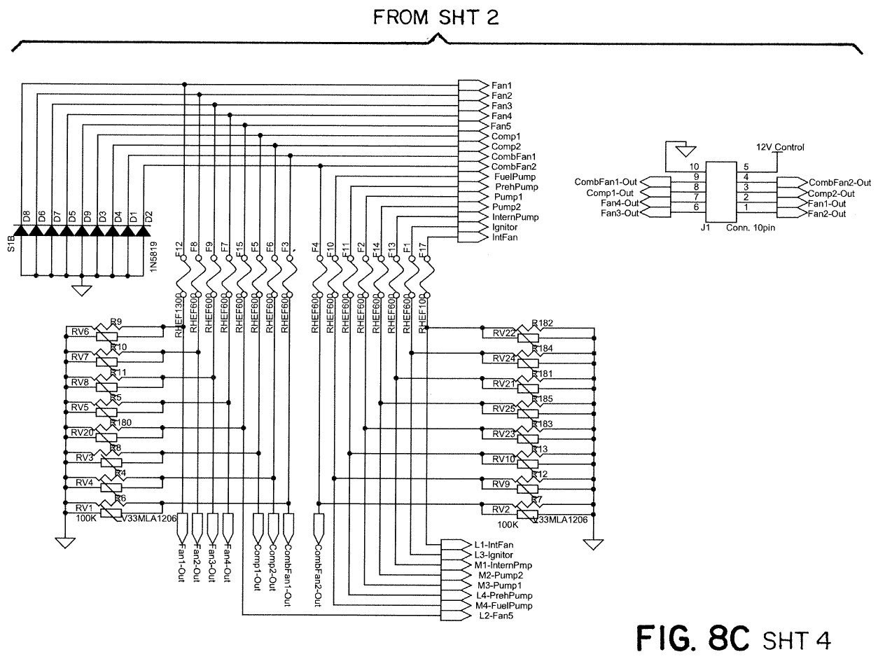

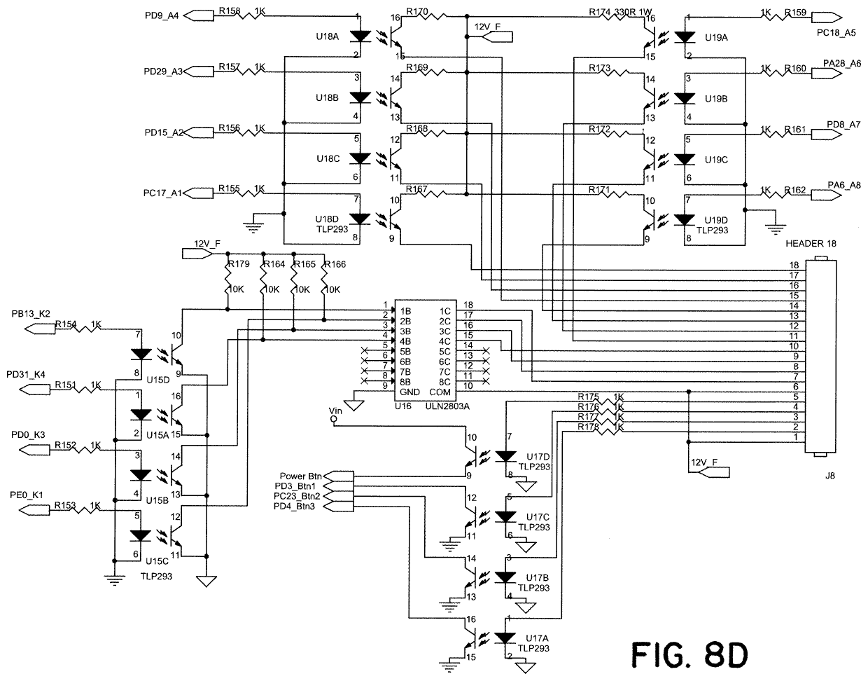

Flow switch 120 is located within the potable water line 140 (FIGS. 1 and 2). The flow switch 120 indicates when there is potable water flow within potable water line 140. The flow switch 120 is of the flapper valve type that sends a signal to circulation pump 111 through a control board 141 (FIG. 8A) to immediately commence pumping hot coolant from coolant tank 101 to heat exchanger 112. This technique is useful to maintain the temperature in the potable water line 140 without the temperature reducing by a noticeable amount due to pump delay and substantially reduces any uncomfortable “cold dip” in the water emanating from the faucet 114.

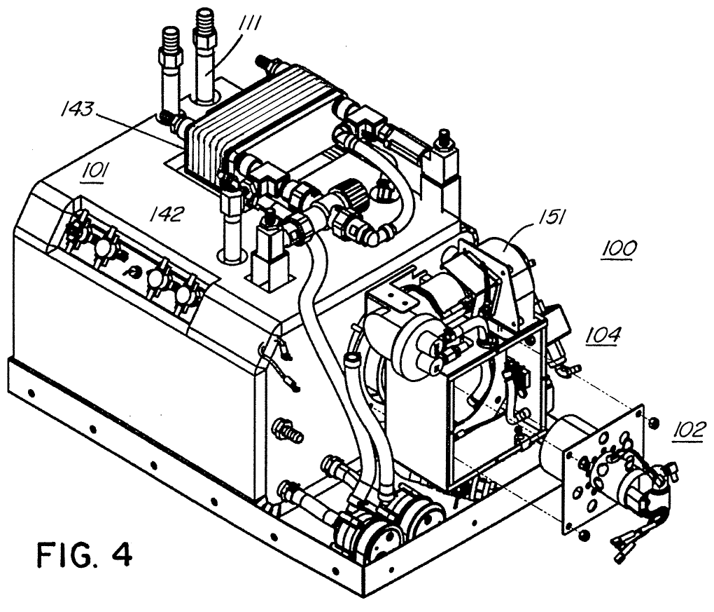

Reference is now made to FIG. 4 where the diesel heater 100 is shown in a modified form according to the invention where the cycling aquastat 125 of the FIG. 2 embodiment is replaced with a coolant thermistor 142. The thermistor 142 is a resistor type temperature sensor that extends into the actual coolant in tank 101 and changes resistance under coolant temperature changes indicating actual coolant temperature to the control board 141 (FIG. 8) which reflects the control system used with the potable water and coolant thermistors 142, 143. It will be understood that references made to “thermistor” or “thermistors” in the present specification and claims are intended to include all such probes or sensors where resistance changes dependent on liquid temperature changes are used. Such thermistors are advantageous over the cycling aquastat 125 illustrated in FIG. 2 because the coolant temperature is precise and obtained virtually instantaneous rather than being imprecise and slower to operate which is a deficiency of aquastats. Likewise, a potable water thermistor 143 is inserted into the potable water line 140 (FIGS. 1 and 4). The potable water thermistor 143 is likewise advantageous since it will take the instant temperature of the potable water in water line 140 and also provide that temperature information to the control board 141.

### Operation

In operation and following placement and installation of the dual loop hydronic heater 100 in the motor coach (not illustrated), the auxiliary heater 100 needs to be initially filled with coolant as is known. An overflow bottle 144 is connected to the coolant tank 101 (FIG. 1). A level control switch (not illustrated) in the coolant tank 101 senses whether there is sufficient coolant in the tank 101 and if there is sufficient coolant, the operation of the coolant pumps 111, 104, 110 will commence which allows the coolant to fill all of the coolant lines which extend to the fans of LOOP 1, the fans of LOOP 2 and the coolant line extending to heat exchanger 112. A level switch 162 (FIG. 5) in the coolant tank 100 will indicate when the coolant drops below the desired level and will terminate operation of the coolant pumps 104, 110, 111 thereby preventing the pumps 104, 110, 111 from running dry without coolant which condition can cause heat buildup and pump seizing.

It will next be assumed that the hydronic heater 100 is ready for the commencement of normal operation with a full tank of cool coolant.

The auxiliary heater 100 will remain in the condition of full (and cool) coolant without power until a power switch (not illustrated) is activated to turn on the auxiliary heater 100.

With the power switch activated and power being applied to the auxiliary heater 100, the coolant thermistor 142 (FIGS. 1 and 4) senses the temperature of the unheated coolant in the recently filled coolant tank 101 and instructs the burner assembly 102 through the control board 141 to commence operation. The igniter 145 (FIG. 2) will commence operation as is known. After approximately ten (10) seconds, a combustion fan 151 will supply combustion air to the burner 102 through air intake holes 152. The fuel pump 153 will pump fuel to the fuel regulator 155 and the solenoid 160 will open to allow the fuel from the fuel pump 153 and fuel regulator 155 to travel to the nozzle in the nozzle holder 154. The operation of the compressor 130 is initiated which will provide air under pressure to the nozzle through nozzle holder 154 and air tube 160. The air compressor 130 draws fuel from the regulator 155 through the fuel solenoid 160, by way of a venturi effect at the tip of the air siphon nozzle. Combustion will commence when the atomised fuel leaving the nozzle contacts the heated element of the igniter 145. The igniter 145 will terminate operation approximately twenty (20) seconds from commencement of the igniter operation.

As combustion continues, the coolant within the coolant tank 101 will increase in temperature until the coolant thermistor 142 reaches its programmed high temperature depending upon the heating mode and its associated temperature selected by the user through the touch screen 161. Three different modes are available to the user through the touch screen 161 connected to the control board 141.

The first NORMAL mode has three associated operating conditions. If there is no call for heat and the electric heating elements 134, 135 and burner 102 are both selected to provide coolant heat, the burner 102 and electric heating elements 134, 135 will be used simultaneously to heat the coolant. The cycle ON temperature is 145 deg.F. and the cycle OFF temperature is 180 deg.F. If there is a call for space heating from the fans in LOOP 1 and/or LOOP 2 and if the burner 102 and the electric heating elements 134, 135 are used simultaneously to heat the coolant, and if the coolant temperature drops below 145 deg.F., the burner 102 and electric elements 134, 135 will be used until the coolant reaches 180 deg.F. If there is a call for hot potable water in the NORMAL mode, the electric heating elements 134, 135 will be used to heat the coolant. If the temperature of the potable water drops below 150 deg.F. as measured by potable water thermistor 143, the electric elements 134, 135 will be run until the coolant reaches 180 deg.F. If the coolant temperature falls below 131 deg.F., the burner 102 will also be used to heat the coolant until the coolant temperature reaches 180 deg.F. This procedure allows for the elements 134, 135 to heat the coolant and keep up with the hot water demand if it is minimal so that the burner 102 does not need to fire. This procedure results in fuel savings. The aforementioned NORMAL mode provides a minimum potable hot water temperature rise of approximately 60 deg.F. at 1.5 GPM. If the electric heating elements 134, 135 are also used, the temperature rise will be higher.

The ECO mode selected on touch screen 161 is typically used in summer when the ground water temperature is warmer. It also has three operating conditions. If there is no call for heat and AC power is available and the electric heating elements 134, 135 are selected, the burner 102 will not run to maintain coolant temperature. In this case, the cycle on temperature for thermistor 142 is 145 deg.F. and the cycle off temperature is 180 deg.F. This ECO mode provides fuel savings. If there is a call for space heating in the ECO mode through the fans in LOOP 1 or LOOP 2, the electric elements 134, 135 will provide coolant heat. If the coolant temperature drops below 135 deg.F., the burner 102 will commence operation. The cycle on temperature set by thermistor 142 is 135 deg.F. and the cycle off temperature is likewise 180 deg.F. If there is a call for potable water in the ECO mode, the elements 134, 135 are used to heat the coolant. If the temperature of the potable water drops below 150 deg.F. as measured by potable water thermistor 143, the electric elements 134, 135 will be run until the coolant reaches 180 deg.F. But if the potable water temperature as measured by potable water thermistor 143 falls below 123 deg.F., the burner 102 will also be used to heat the coolant until it reaches 180 deg.F. Again, this procedure will allow the electric elements 134, 135 a greater chance to heat the potable water which will result in fuel savings. In the ECO mode and when using the burner 102, a minimum hot water temperature rise of 50 deg.F. at 1.5 GPM is maintained. The use of the electric elements 134, 135 will increase the temperature rise.

The MAXIMUM mode is intended to have the highest temperature rise available. If there is no call for heat and the electric elements 134, 135 and burner 102 are selected, both will be used to maintain a coolant temperature of approximately 185 deg.F. The cycle ON temperature for the coolant thermistor 142 is 150 deg.F. and the cycle OFF temperature is 185 deg.F. When there is a call for space heating, the burner 102 and the electric elements 134, 135 will together be used to heat the coolant if the temperature sensed by coolant thermistor 142 falls below 150 deg.F. The cycle OFF temperature will again be 185 deg.F. When there is a call for hot potable water, the burner 102 and the electric elements 134, 135 will be used together and at the same time to heat the coolant. The cycle ON temperature sensed by the potable water thermistor 143 will be 150 and the cycle OFF temperature will be 185 deg.F. The MAXIMUM mode will provide a hot water temperature rise of approximately 65-70 deg.F. when the burner 102 is solely used. When the electric elements 134,135 are also used, the temperature rise will be higher. The MAXIMUM mode is particularly useful in the winter when ambient and ground water temperatures are low.

Following shutdown of the burner 102, the combustion fan 151 continues operation for a predetermined time period to cool the burner assembly 102 and to exhaust all combustion gases. The coolant in the coolant tank 101 is then ready for a call for heat from the system.

If the call for heat comes from a thermostat or thermostats (not illustrated) in the living or heating area covered by LOOP 1 or LOOP 2 and with reference to FIGS. 1, 4 and 5, the coolant thermistor 142 determines if there is heat available within the coolant in the coolant tank 101 so that cold air does not come from the fans in LOOP 1 or LOOP 2. Assuming that coolant thermistor 142 indicates coolant heat is available and assuming the level switch 165 (FIG. 5) in the coolant tank 101 indicates there is sufficient supply of coolant, coolant circulation pumps 104 and/or 110 will commence operation and will pump hot coolant from the tank 101 through LOOP 1 and/or LOOP 2. Simultaneously, the fans 163 will turn on and provide warm or hot air to the environment monitored by the thermostats until the temperature indicated by thermostats reaches its desired value and opens thereby terminating operation of the coolant pumps 104, 110.

As the hot coolant leaves the coolant tank 101 and is circulated through the heating LOOP 1 and/or LOOP 2, heat will be depleted from the coolant and the coolant temperature will fall. The coolant thermistor 142 senses the coolant temperature and when the coolant temperature falls to a predetermined value as set out above, the temperature sensed by coolant thermistor 142 will be sensed by the control board 141 and the burner 102 and/or electric elements 134, 135 will commence operation. This will heat the coolant in the coolant tank 101 until it reaches the higher temperature sensed by the thermistor 142 as set out above whereby the control system will terminate the combustion in the burner 102 and/or terminate the operation of the electric elements 134, 135 also as earlier described.

The user may call for hot water from any of several hot water faucets in the motorhome, boat or vehicle and a representative faucet 114 (FIG. 1) is illustrated. If there is a call for hot water from a hot water faucet 114, potable water will begin to move through the potable water line 140 and heat exchanger 112. The flow switch 120 will sense the potable water movement and will send a signal to the control board 141 (FIGS. 8A-8D) and thence to the pump 111 which will commence to pump coolant through the heat exchanger 112 assuming coolant thermistor 142 indicates there is heated coolant available in coolant tank 101. The potable water thermistor 143 is in direct contact with the water in line 140 and continually senses the temperature of the water. As heat is drawn from the coolant by movement through heat exchanger 112, the potable water will reach a lower temperature where the control system 141 programs the burner assembly 102 and/or electric elements to commence operation.

Pump 111 will continue to operate and hot coolant continues to circulate through the heat exchanger 112 thereby heating the potable water. If more heat is being added by he burner assembly and/or electric elements that is being drawn out by the potable water, this will give rise to a temperature of coolant thermistor 142 until the coolant thermistor 142 reaches a predetermined and desired temperature as explained so that the pump 111 will cease operation under the signals sent by the control board 141.

Without the flow switch 120 being located in potable water line 140, a full flow request for hot water may be received such as when the user is in a shower. In this case, the pump 111 may fail to commence immediate operation and the temperature of the hot coolant passing through the heat exchanger 112 may decrease even though the potable water thermistor 143 is sensing a reduction in temperature in the potable water in the potable water line. This is so because the thermistor 143 has not reached a temperature where the control board 141 instructs the pump 111 to commence operation. The flow switch 143 overcomes that problem by immediately instructing pump 111 to commence operation through the control board 141 assuming the coolant thermistor 142 indicates heat is available in the coolant tank 101. Thus, the potable water passing through potable water line 140 to the shower represented by faucet 114 will tend to stay at a stable temperature throughout the draw of potable water by faucet 114. The user will not feel an uncomfortable temperature decrease in the shower water.

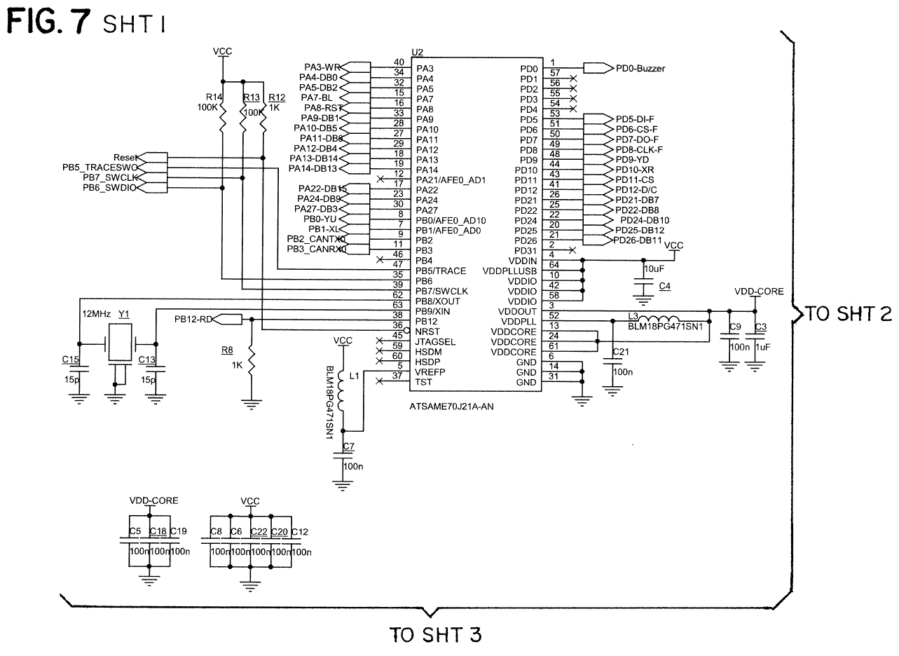

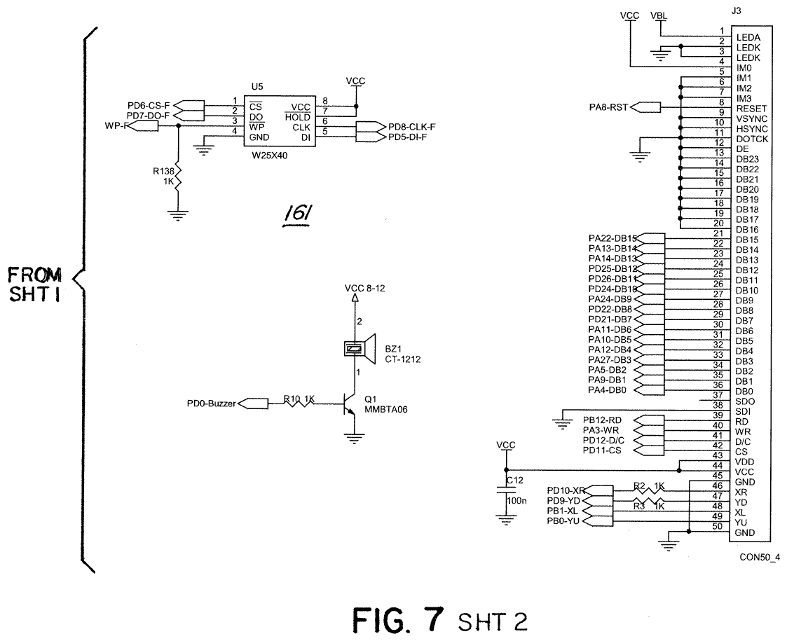

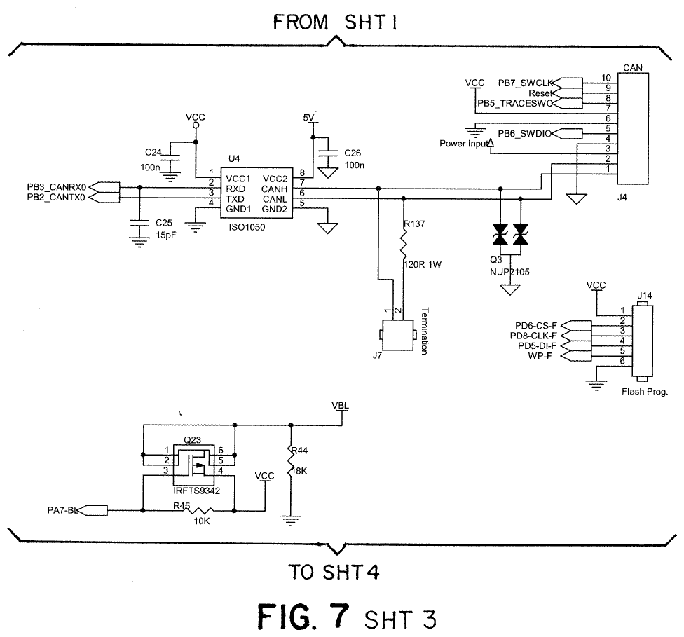

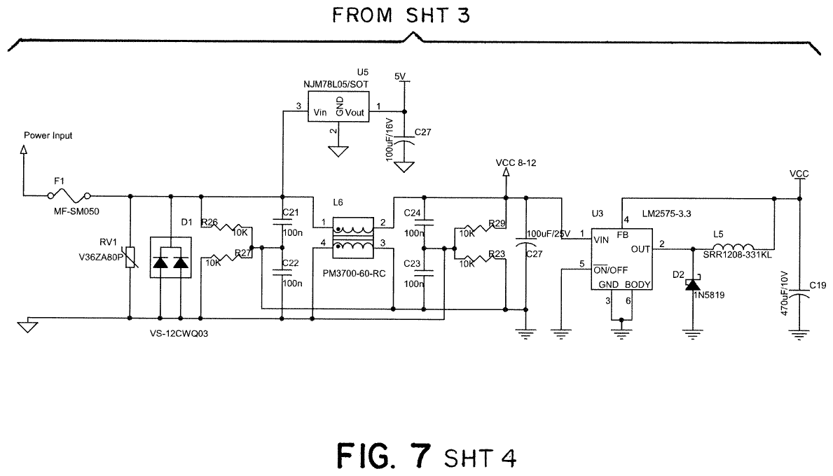

As the hot coolant travels out of the coolant tank 101 through heat exchanger 112, the temperature of the coolant will decrease within the tank 101 because it is being replaced by cooler coolant without the burner assembly 102 being under combustion conditions. Thus, the heat transferred to the potable water in the heat exchanger 112 also decreases. If the call for hot water is low such as turning to a bathroom tap for a short period, there is no need for the burner 101 to commence operation and, therefore, the thermistor 143 acceptably functions to initiate combustion within the burner 102 when it is required. However, if there is a significant call for potable water such as for a shower, it is desirable to commence operation of the burner assembly 102 well before the cycling aquastat 202 closes in order to avoid a hot water temperature reduction prior to commencement of the operation of the burner 102. The three MODES described earlier may set up a unique and flexible operation for hot water and burner operation in which the user programs the control system 141 through the touch screen 161 (FIG. 7) which utilizes the coolant and potable water thermistors 142, 143. The use of the coolant and potable water thermistors 142, 143 instead of aquastats allows a far more flexible and accurate response of the heating system 100 than would be ordinarily possible with the use of coolant and potable water aquastats only.

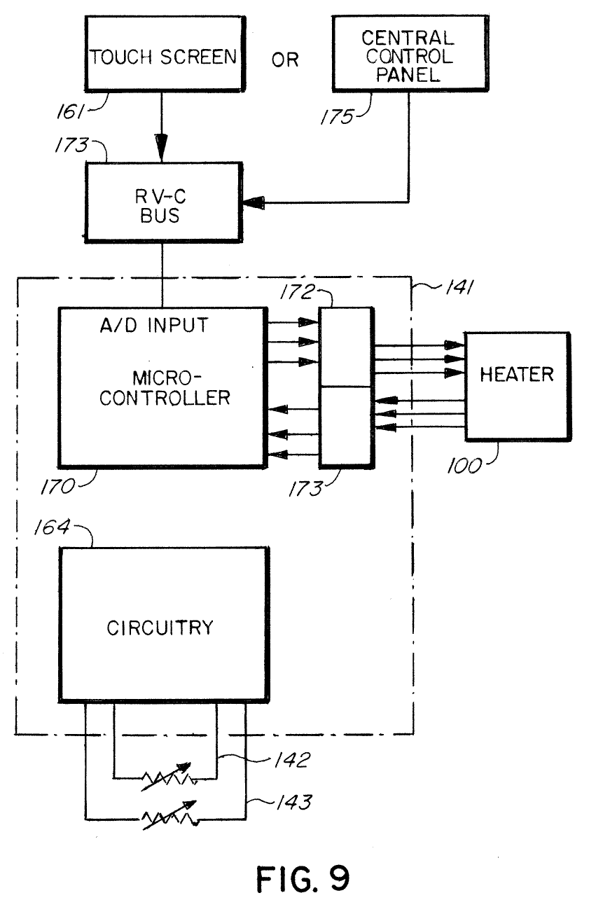

A diagrammatic flow chart illustrating the various components serving the hydronic heater 100, the control board 141 and the touch screen 161 is generally illustrated in FIG. 9. The coolant thermistor 142 and the potable water thermistor 143 connected to the circuitry components generally illustrated at 164 which convert the resistance information from each of the thermistors 142, 143 into voltages that can be processed by the micro controller generally illustrated at 170 with an analog/digital (A/D) input port. The A/D inputs received from each of the thermistors 142, 143 are processed within the micro controller 170 and determines the temperature of the coolant and potable water. It then passes appropriate output signals to the heater circuitry which powers the components of the heater 100 and controls the various heater components represented by the heater 100. The heater circuitry used to power the various heater components is generally illustrated at 172 and this power is passed to the various ones of the heater components such as the compressor 130, combustion fan 151, ignitor 145, etc. The inputs received from the heater components are generally illustrated at 173 and these processed inputs are subsequently passed to the micro controller 170 for processing and comparison with the incoming signals received from thermistors 142, 143 and puts relevant information from the heater 100 on the RV-C bus such as the coolant temperature, compressor status, voltages, altitude, combustion efficiency, BTU and exhaust outputs, oxygen sensor. altitude compensation, etc. This relevant information can then be displayed on the touch screen 161 or central control panel 175 such as a panel produced by SILVERLEAF which is currently used in various vehicles.

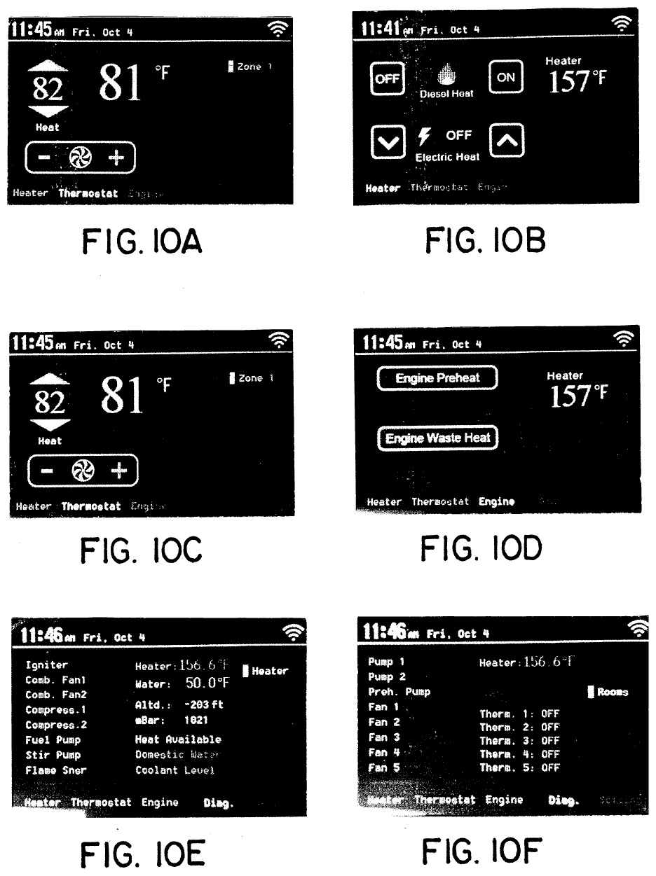

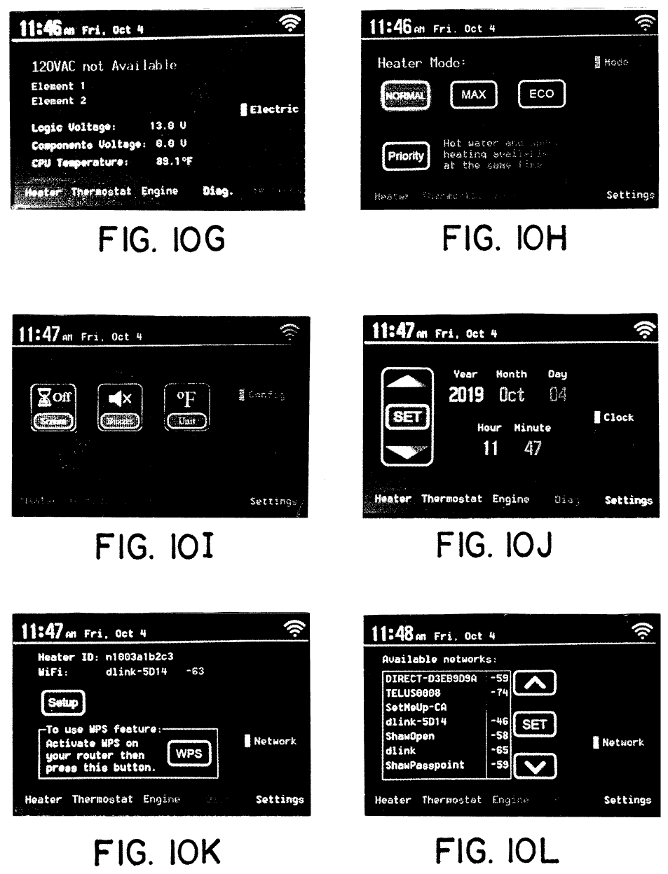

A touch screen (FIGS. 10A-10L) 161 acts as the control and monitor panel of the control system and interfaces between a user and the control system. Its display includes a time section where the current date and time (FIG. 10A) is shown. In the right side of this area the WiFi icon is displayed. The icon color is dark grey when disconnected and bright white when a connection is established. The main menu is displayed in the bottom of the screen. Each item in the main menu is a screen that monitors and controls different features of the heating system. The selected screen is highlighted. The default screen is Heater at power up. The Thermostat, Diag. and Settings screens contain submenus. Submenus are displayed on the right side of the screen and allow selecting sub-screens in each of the above mentioned screens. The selected sub-screen shown, for example, at Thermostat is highlighted.

The Heater Screen (FIG. 10B) displays the status of the burner and electric heating elements. The ON and OFF buttons on this screen switch ON and OFF the demand for the burner. The flame icon shows when the burner is ON. The lightning bolt icon indicates if the 120 VAC electric power is available. When available the icon color will be yellow. Otherwise, it will be grey. The arrow buttons switch ON and OFF the demand for the activation of the two electric heating elements 134, 135 (OFF/1.5 KW/3.0 KW). The text color indicates if the electric element(s) are ON by changing color to yellow. On the right side of the screen the heater's coolant temperature is displayed. The Thermostat Screen (FIG. 10C) displays the current temperature, heat set point temperature, fan speed settings (Low, Medium, High) and the fan running status. The arrow buttons increase or decrease the set point temperature. For the zones that have a separate thermostat installed such as in living quarters, the ambient temperature and set point temperature indication is replaced by the thermostat state ON or OFF indication. The Plus and Minus buttons decrease and increase the fan speed setting and the Fan icon is displayed in white when the fan is running and grey when the fan is stopped. Different zones can be selected using the sub-screen buttons, Zone 1 to 5. For example, Zones 1 to 4 correspond to the living room, the kitchen, the bathroom and the bed room, respectively. The Engine Screen (FIG. 10D) shows Engine Preheat and Waste Heat functions which are monitored and controlled in this screen. The Engine Preheat button toggles the function ON and OFF. The engine pre-heat pump (not illustrated) will turn ON only when heat is available (coolant temperature above 120° F.). The Priority setting will affect this function as described in the Settings Screen shown in FIG. 10 E below. The Engine Waste Heat button toggles the corresponding function ON and Off. The heat of the running vehicle's engine is used for heating the coolant. This function is disabled when the engine is not running. The Diag. Screen shows complete diagnostics information of the heater is displayed on this screen. The screen contains three sub-screens: Heater, Rooms and Electric. In each, the related information is shown. In the Heater sub-screen (FIG. 10E), the status of the burner components of the heater 101 are displayed on the left side. Grey text indicates the component being OFF, red text indicates a fault and green text indicates it is ON. When a component is ON, its current draw is shown in front of its name in green. The coolant temperature and the hot potable water temperature (before the mixing valve 113) are shown in the second column. Other information in this column are the altitude and the atmospheric air pressure of the system's location, the heat available status (when coolant is over 120 F), the indication of a call for potable water and the status of the coolant level. In the Rooms sub-screen (FIG. 10F), the status of the room's system components are displayed on the left side. The same text color of grey, green and red are used here to show OFF, ON and fault status of the components, respectively and current draw is shown for every running component in green. In the second column, the heater's coolant temperature and the room's ambient temperature or its thermostat status are shown. In the Electric screen (FIG. 10G), the 120 VAC electric power and electric heating element(s) status are shown. In the lower section, the Logic Voltage value (power to the control board) and the Components Voltage value (power to the heater components) and the control board temperature are shown.

In the Settings screen the parameters that control the functions of the heater and the touch screen are shown with its four sub-screens. The heater can operate in three different modes (FIG. 10H), which offer performance and fuel savings options. The ECO mode will attempt to use the electric heating elements as much as possible and will run the burner only when the electric heating elements can't keep up with the demand. Use this mode in the summer when the ground water temperature is higher. The heater will have the greatest fuel savings in this mode. The MAX mode will maximize the heat generated from the system and this mode will generally be used in cold or winter conditions when the ground water temperature is colder. The heater will have higher fuel consumption operating in this mode. The NORMAL mode provides standard performance and is meant for year-round use. The heater will have average fuel usage in this mode. The PRIORITY button toggles the priority of the potable hot water. With the Priority set to ON, calling for potable hot water will disable the space heating and engine pre-heat functions. With priority set to OFF, the space heating and engine pre-heat functions will work at the same time as a call for potable hot water. The Config screen (FIG. 10I) includes three buttons that set the touch screen operating parameters. The Screen button sets the sleep time for the screen. The display will turn off, but the heater will continue normal operation. Touching the screen will turn the display back ON. Sleep time can be set to 5 minutes, 3 minutes, 1 minute or disabled. The Buzzer button enables or disables the touch screen buzzer. The buzzer beeps for 4 seconds in case of a heater fault. The Unit button toggles the display of temperature on the Touch Screen in ° F. or ° C. The Clock sub-screen (FIG. 10J) allows the setting of the heater's internal clock. The heater's clock will be used if the screen does not receive date and time information from other devices on the vehicle's network. After the desired date and time is set using the arrow buttons, the SET button is used to save the setting. The Network sub-screen (FIG. 10K) is for setting the WiFi connection of the heater so that heaters with WiFi connected can be monitored and controlled through handheld devices using Android and iOS. The Heater ID shown on the top of the screen will be used when setting up the relevant App. If the WiFi is connected, the name of the network will be shown in the second row of the screen. To connect to a WiFi, the Setup or WPS button in this screen can be used. If the WiFi's router has a WPS feature, the WPS button on this screen can be used to connect to the WiFi without the need to enter its password. To use this feature, WPS should be activated on the router, then the WPS button touched. The system will connect to the WiFi after few seconds. To connect to the WiFi using the name and password, press the Setup button. The next screen (FIG. 10L) shows a list of available WiFi networks. The arrow keys are used to select the desired network and the SET button is pressed. The password for the selected WiFi is entered in the next screen and the Save button is pressed.

Where aquastats are intended to be used despite their disadvantages, it is contemplated the coolant aquastat 146 could be mounted on the heat exchanger 112 as shown in FIG. 2. Aquastat 146 reacts more quickly to temperature changes on the heat exchanger 112 as it does in the position on the surface of coolant tank 101 which is desirable. The circulation pump associated with the coolant moving through the heat exchanger 112 needs to be operating to circulate the coolant in coolant tank 101 through the heat exchanger 112 and if the coolant pump fails. The use of the high limit aquastat 124 will continue to shut down the burner 102.

Many advantages are thus seen with the control system according to the invention and to the use of thermistors with the burner assembly to precisely communicate the temperatures of the coolant and potable water in a heating system according to the foregoing description. These advantages include the previous zone board being incorporated into the control board, the elimination of any RV control board between the previous control board and that the RV bus is now integrated with the control board according. There are fewer wire harnesses required and since the circulation pumps required by the heating loops and heat exchanger loop are located in the bottom area of the coolant tank 101 and heater 100, the changes of the pumps running dry and failing are reduced. Similarly, because the fill/drain port in the coolant tank 101 is located in the lower area of the tank 101, the fill and empty operation is simplified and any need for a high pressure purge pump is eliminated.

An oxygen sensor may be included in the burner assembly 102 to sense the quantity of oxygen in the combustion air. This may be advantageous if the burner 100 is operated at altitudes where the is less oxygen available and required for optimum combustion. In the event the oxygen sensor senses that the oxygen needed for optimum combustion is not correct, a change in the combustion air could be controlled by increasing or decreasing combustion air by varying the output of either or both of the combustion fan 151 and the compressor 130. Thus a modulated heat output from the burner assembly 102 could be obtained with its concomitant advantages.

Many other modifications to the invention may be readily contemplated and while the specific embodiments of the heater and the control system have been described in the specification, such embodiments are intended to be illustrative of the invention only and not as defining its scope as construed in accordance with the accompanying claims.

We claim:

1. A hydronic heating system comprising a source of potable water, a coolant reservoir to hold coolant, a heat exchanger to exchange heat between said coolant and said potable water, a thermistor to sense the temperature of coolant in said coolant reservoir and to send a signal corresponding to said temperature sensed to said control system, a burner assembly controlled by said control system to apply heat to said coolant, said control system initiating or terminating combustion within said burner assembly thereby to regulate the heat applied to said coolant in said coolant reservoir.

2. A hydronic heating system as in claim 1 and further comprising a coolant line extending from said coolant reservoir to said heat exchanger and a coolant pump in said coolant line to move said coolant through said heat exchanger responsive to a signal from said control system.

3. A hydronic heating system as in claim 2 and further comprising a source of potable water, a potable water line extending from said source of potable water to said heat exchanger, a faucet connected to said potable water line downstream of said heat exchanger, a thermistor in said potable water line located downstream from said heat exchanger and a mixing valve positioned between said potable water line upstream and downstream of said heat exchanger, said thermistor acting to send a signal to said control system responsive to temperature changes in said potable water, said control system controlling the operating of said coolant pump in said coolant line.

4. A hydronic heating system as in claim 3 and further comprising a first space heating loop extending from said coolant tank and a first coolant pump in said first space heating loop, said first coolant pump being controlled by said control system.

5. A hydronic heating system as in claim 4 and further comprising a second space heating loop extending from said coolant tank and a second coolant pump in said second space heating loop, said second coolant pump being controlled by said control system.

6. A hydronic heating system as in claim 5 and further comprising a user operated touch screen connected to said control system, said touch screen allowing communication with said control system and having a user readable display displaying coolant and potable water temperatures.

7. A hydronic heating system as in claim 6 and further comprising fans in said first space heating loop, said fans having a variable speed responsive to said touch screen.

8. A hydronic heating system as in claim 7 and further comprising fans in said second space heating loop, said fans having a variable speed responsive to said touch screen.

9. A hydronic heating system as in claim 8 and further comprising an oxygen sensor in said burner assembly to sense combustion efficiency, a combustion fan connected to said burner assembly to provide combustion air to said burner assembly and a compressor to provide compressor air to said burner assembly, said oxygen sensor sending a signal to said control system, said control system regulating the output of said combustion air and said compressor air from either or both of said compressor and said combustion fan.

10. A hydronic heating system as in claim 9 and further comprising a flow switch in said potable water line to sense potable water movement when said faucet is opened, said flow switch sending a signal to said control system when said potable water movement in said potable water line commences, said control system sending a signal to said coolant pump in said coolant line to regulate the operation of said coolant pump under said signal from said flow switch.

11. A temperature sensing system comprising a coolant tank, a coolant line extending from said coolant tank to a heat exchanger and an temperature sensing device mounted on said heat exchanger.

12. A temperature sensing system as in claim 11 wherein said temperature sensing device is an aquastat.

13. A method of controlling a hydronic heating system comprising heating a source of coolant by a burner, passing coolant from a source of said coolant through a heat exchanger under the direction of a control system, measuring the temperature of said coolant by a thermistor being a resistor producing an electrical signal responsive to changes of resistance by the change of temperature in said coolant, processing said electrical signal in said control system and producing an output signal from said control system to said burner to commence, continue or terminate said heating of said coolant.

14. A method as in claim 13 wherein said coolant is passed from said source of coolant to said heat exchanger by a coolant pump under the control of said control system.

15. A method as in claim 14 and further comprising passing potable water from a source of potable water through a potable water line to a heat exchanger.

16. A method as in claim 15 and further comprising detecting the flow of potable water in said potable water line by a flow switch passing a signal to said control system.

17. A method as in claim 16 wherein said control system controls said coolant pump by signals sent from said control system to said coolant pump, said signals sent from said control system being responsive to said signal from said flow switch.

18. A method as in claim 16 and further sensing the temperature of said potable water in said potable water line by a resistor being a thermistor with a change of resistance depending upon the temperature of said potable water, said thermistor passing a temperature dependent signal to said control system and said control system sending a signal to a touch screen where said temperature of said potable water is displayed to a user.

19. A method as in claim 18 wherein said temperature dependent signal sent by said potable water thermistor sends a signal to said control board to commence the combustion in said burner when said temperature in said potable water falls below a predetermined value.
